(19) United States
(12) Patent Application Publication
(10) Pub. No.: US 2010/0328209 A1
(43) Pub. Date: Dec. 30, 2010

(54) INPUT DEVICE FOR ELECTRONIC APPARATUS

(75) Inventor: Masatoshi Nakao, Yokohama-shi (JP)

Correspondence Address: Seed Intellectual Property Law Group PLLC, 701 Fifth Avenue, Suite 5400, Seattle, WA, 98104, US

(73) Assignee: PANASONIC CORPORATION, Kadoma-shi (JP)

(21) Appl. No.: 12/867,713

(22) PCT Filed: Dec. 4, 2008
(86) PCT No.: PCT/JP2008/003606

§ 371 Date: Aug. 13, 2010

(30) Foreign Application Priority Data
Feb. 15, 2008 (JP) 2008-034330

(51) Int. Cl. G06F 3/033

(52) U.S. Cl. 345/157

(57) ABSTRACT

In a case where a user carries out input operation by use of a touch panel, operability can be improved even if the operation target is small, efficient input operation is enabled by the user in various situations. The screen generation unit 200 generates screen display information of a display screen including an operation object being an operation target. A size or the like of the operation object on the display screen is judged by the minute operation presence/absence judgment unit 210 and in a case where an operation object which cannot be easily operated by a user's finger is included, the virtual stylus display control unit 310 generates display information of the virtual stylus as a pointer for carrying out instruction input to the operation object. The screen display control unit 300 combines screen display information of the display screen from the screen generation unit 200 and display information of the virtual stylus from the virtual stylus display control unit 310 to generate screen data of the display screen and outputs the screen data to the display unit 10 for display.

### TECHNICAL FIELD

The present invention relates to an input device for an electronic apparatus usable for input operation of an electronic apparatus such as a cellular phone terminal, a personal digital assistant (PDA), a portable music player, or a portable video game machine.

### BACKGROUND ART

For the purpose of improving operability for a user or reducing the number of mechanical operation buttons, recently, touch panels are often adopted for various electronic units for input operation by a user. Such a touch panel includes a display unit that can display various types of information and a touch sensor for detecting a contact position of a user's finger or a fine-tipped pen (a stylus) on the display. Then, an object such as a button which can be operated is displayed on the display unit as visible information and a display position of each object and a position detected by the touch sensor are made to correspond and input processing is carried out. That is, if a user touches a position of a specific object displayed on the display unit by a finger etc., the electronic apparatus recognizes that the position detected by the touch sensor matches the position of the object and the electronic apparatus carries out a function allocated to the object. Thus, a number of mechanical operation buttons do not need to be provided. Moreover, it becomes possible to freely change the position, number, shape, or the like of the operation button by changing information indicating the correspondence relationship between the content of the object displayed on the display unit, the position of each object, and coordinates on the touch panel without making a change to the hardware.

Meanwhile, because the size of a portable terminal such as a cellular phone terminal is relatively small, the size of the display unit to be mounted thereon is also small. Therefore, displaying a number of objects to which different functions are respectively allocated in order to enable various input operations by the user, display size of each object must be set small.

Even in a case where a relatively smaller object is operated, when a fine-tipped pen is used, it is relatively easier to distinguish and operate each object. However, if a user touches the display to operate the object by a finger, it is difficult to operate a small-sized object. For example, an object which is an operation target is hidden by a finger and cannot be seen by the user and if a space between adjacent objects is narrow, there is a possibility that a plurality of objects would be touched simultaneously by the same finger and therefore an incorrect operation is prone to occur.

Further, in a case where such a portable terminal is operated, such a situation can be assumed wherein a user holds the apparatus main body with one hand, and operates the respective objects displayed on the screen by one hand in a manner of moving his/her thumb or another finger of the holding hand. However, to operate the apparatus by use of a pen as mentioned above, the user must use both hands and therefore operability in such a case is not very good. Accordingly, it is preferable that the apparatus can be operated without incorrect operations by use of only a finger of the user without using a pen.

For example, the Patent Document 1 discloses a conventional art for correctly and easily specifying a selection item (equivalent to an object) even in a case where a user operates selection items displayed with narrow display space by a finger. In the Patent Document 1, it is suggested that a pointer corresponding to the operation position is displayed in a position distant by a predetermined distance from a position on the display where a finger touched. Accordingly, because a selection item is specified by indirect operation via a pointer displayed in a position not hidden by a finger, operability can be improved.

Moreover, a conventional art regarding the shape of a pointer in a case where a similar pointer is operated by a pen tip is disclosed in the Patent Document 2. In the Patent Document 2, the shape of a pointer is configured by combination of a round area for being touched by the pen and an arrow-shaped area to enable more accurate position designation when a pen is used.

Moreover, a conventional art with regard to pointer operation is disclosed in the Patent Document 3. The Patent Document 3 suggests distinguishing and receiving two types of operation, operation for displaying and moving the pointer and click operation.

### Patent Document 1: JP-A-6-51908

### Patent Document 2: JP-A-6-161665

### Patent Document 3: JP-A-2000-267808

### DISCLOSURE OF THE INVENTION

### Objects to be Solved by the Invention

If the pointer is displayed on a screen and an object is operated indirectly by use of the pointer as described in the Patent Documents 1, 2, and 3, operability can be improved in a case where a small-sized object is operated by a finger.

However, in a case where the pointer is used, it is necessary to separately carry out operation to move the pointer to determine the position thereof and the operation to select (to click) as in the Patent Document 3. Therefore, there is a problem that the operation becomes more complicated compared to a case where each object is directly operated by a finger. For example, in such a situation that an object such as an operation button displayed on a screen is large enough, there is a case where the operation can be carried out efficiently with fewer operation procedures if the object is directly operated by a finger without using a pointer compared to a case where the pointer is used. Moreover, there is another problem that if the pointer is displayed, a part of the displayed content on the screen is hidden by the displayed pointer or is overlapped with the pointer and therefore the displayed pointer may obstruct operation by the user in a case where there is no need to use a pointer.

The present invention has been made in consideration of the above-mentioned circumstances, and a purpose thereof is to provide an input device for an electronic apparatus which can improve operability even in a case where a user carries out input operation by use of a touch panel and an operation target is small or the like, and enables efficient input operation by the user in various situations.

### Means for Solving the Object

An input device for an electronic apparatus according to the present invention includes a display unit that can display visible information regarding an input operation, an input operation unit that includes a touch panel having an input function by a touch operation on an input screen corresponding to a display screen of the display unit, an input control unit that instructs a processing based on input signals from the input operation unit, an operation object display control unit that displays at least one operation object as visible information indicating an operation target portion for instructing execution of a specific function on the display unit as the visible information via the input operation unit, and a pointer display control unit that has a function to display a pointer being movable on the display screen for carrying out input of an instruction to the operation object via the input operation unit on the display unit as the visible information, displays or hides the pointer in accordance with the information of the operation object displayed on the display unit, and displays the pointer in a case where a width or a size of the display area of the operation object displayed on the display unit or a width or a size of an area for receiving the input operation is equal to or smaller than a predetermined value as information of the operation object.

Thus, the pointer is displayed in response to information of the operation object, in a case where the width or the size of the display area of the operation object displayed on the display unit or the area for receiving the input operation is equal to or smaller than the predetermined value, therefore a user can operate the operation object by the pointer. In this case, an indirect operation by the pointer is enabled in a condition where a direct operation using the touch panel is not easy due to the small operation object and operability can be improved. Therefore, the pointer can be displayed and made available as necessary corresponding to the situation of the display screen and operational efficiency or convenience can be improved.

Moreover, the present invention is the input device for the electronic apparatus wherein the pointer display control unit displays the pointer in a case where a contact area on the input screen of the input operation unit a during touch operation is equal to or greater than a predetermined value.

Thus, in a case where the contact area on the input screen of the input operation unit during the touch operation is equal to or greater than the predetermined value, it is regarded that a user is operating the touch panel by his/her finger and the pointer is displayed to enable direct operation by the pointer. Moreover, if the contact area is smaller than the predetermined value, it is regarded that the user is operating by use of a stylus having a fine tip or the like and the pointer can be hidden. Therefore, unnecessary display of the pointer can be inhibited. Thus, displaying/hiding of the pointer can be switched as necessary.

Further, the present invention is the input device for the electronic apparatus wherein the pointer display control unit sets a display position of the pointer in the vicinity of an area including an operation object corresponding to a display condition of the pointer, and the display position of the pointer does not overlap the operation object when displaying the pointer.

Thus, the pointer can be displayed in an appropriate position that does not obstruct display or operation of the operation object in an initial condition of a pointer display or the like.

Further, the present invention is the input device for the electronic apparatus, wherein the input control unit can receive input signals by either input operations such as direct operation to the operation object on the display screen or indirect operation to the operation object on the position of the pointer as the input operation corresponding to the display screen of the display unit.

Thus, both the direct operation to the operation object and the indirect operation to the operation object using the pointer can be carried out. Therefore, it becomes possible to carry out either the direct operation or the indirect operation corresponding to the situation. Therefore, an efficient input operation by a user in various situations is enabled and operational efficiency can be improved.

Further, the present invention is the input device for the electronic apparatus, wherein the pointer display control unit sets a first condition wherein the indirect operation to the operation object by the pointer is invalid and a second condition where the indirect operation to the operation object by the pointer is valid when displaying the pointer, and switches the first condition and the second condition in accordance with a detection situation of the input operation to the pointer.

Thus, it becomes possible to switch respective valid/invalid conditions of indirect operation by the pointer depending on the input operation situation to the pointer and occurrence of unintended incorrect operation by the user can be inhibited.

Further, the present invention is the input device for the electronic apparatus, wherein the pointer display control unit displays the pointer switching display mode of the pointer in accordance with the first condition and the second condition.

Thus, it becomes possible to easily recognize the condition of the pointer, prevent occurrence of an incorrect operation, and improve visibility or operability.

Further, the present invention is the input device for the electronic apparatus, wherein the pointer display control unit adds a selection display indicating that an operation object at the display position of the pointer or in the vicinity of the display position of the pointer is selected by the pointer in a case where the pointer is in the second condition.

Thus, the condition of the pointer or the selection condition of the operation object can be easily recognized and visibility or operability can be improved.

Further, the present invention is the input device for the electronic apparatus, wherein the pointer display control unit uses character patterns, whose form can be changed, as the pointer and carries out animation display of the character pattern.

Thus, the user can intuitively understand the current operation condition such as moving by the change in form of the pointer and efficient input operation by use of the pointer is enabled. Moreover, it is also possible to improve usability providing the pointer display with an amusement factor.

Further, the present invention is the input device for the electronic apparatus, wherein the pointer display control unit changes a form including at least either a shape or a size of the pointer corresponding to a form of the contact area in the input screen of the input operation unit during the touch operation.

Thus, it is possible to display the pointer having an appropriate form corresponding to the size or shape of the contact area of each user, and visibility or operability can be improved.

Further, the present invention provides an electronic apparatus mounted with any of the above-mentioned input devices.

### EFFECTS OF THE INVENTION

According to the present invention, in a case where a user carries out input operation by use of a touch panel, operability can be improved even when an operation target is small or the like and it becomes possible to provide an input device for an electronic apparatus which enables efficient input operation by a user in various situations.

### BRIEF DESCRIPTION OF THE DRAWINGS

FIG. 1 A block diagram showing configuration of a main body of an input device for an electronic apparatus according to an embodiment of the present invention.

FIG. 2 A view showing an example of display content on a display screen of the input device according to the embodiment.

FIG. 3 A view showing a specific example of operation procedures by a user to the display screen of the input device according to the embodiment.

FIG. 4 A sequence diagram showing performance with regard to display control of a virtual stylus in the input device according to a first embodiment.

FIG. 5 A sequence diagram showing performance with regard to reception of input operation in a virtual stylus display condition in the input device according to the first embodiment.

FIG. 6 A view showing an example of display content on the display screen and performance in response to operation by a user in the input device according to a second embodiment.

FIG. 7 A view showing transition of condition of a virtual stylus displayed on the display.

FIG. 8 A flowchart showing processing procedures in the input operation to the virtual stylus in the input device according to the second embodiment.

FIG. 9 A sequence diagram showing performance with regard to reception of input operation in a virtual stylus display condition in the input device according to the second embodiment.

FIG. 10 A schematic view showing a difference in operation positions corresponding to a judgment result of direct or indirect operation.

FIG. 11 A view showing an example of display content on the display and performance in response to operation by a user in the input device according to a third embodiment.

FIG. 12 A sequence diagram showing performance with regard to reception of input operation in a pointer display condition in the input device according to the third embodiment.

### DESCRIPTION OF REFERENCE NUMERALS

10 Display unit
11, 11A to 11M Display screen
12 Operation object
13 Virtual stylus
13a Main area
13b Projection area
14 Finger
20 Touch panel
30 Screen data storing unit
50 Pointer
51a, 51b Selection display
60 Processing target
100 Application
200 Screen generation unit
210 Minute operation judgement unit
300 Screen display control unit
310 Virtual stylus display control unit
400 Input signal analysis unit
410 Virtual stylus condition management unit
500 Input signal control unit

### BEST MODE FOR CARRYING OUT THE INVENTION

In the following embodiments, a configuration example in which an input device for an electronic apparatus is applied as an example to a mobile electronic apparatus such as a cellular phone terminal is shown.

### First Embodiment

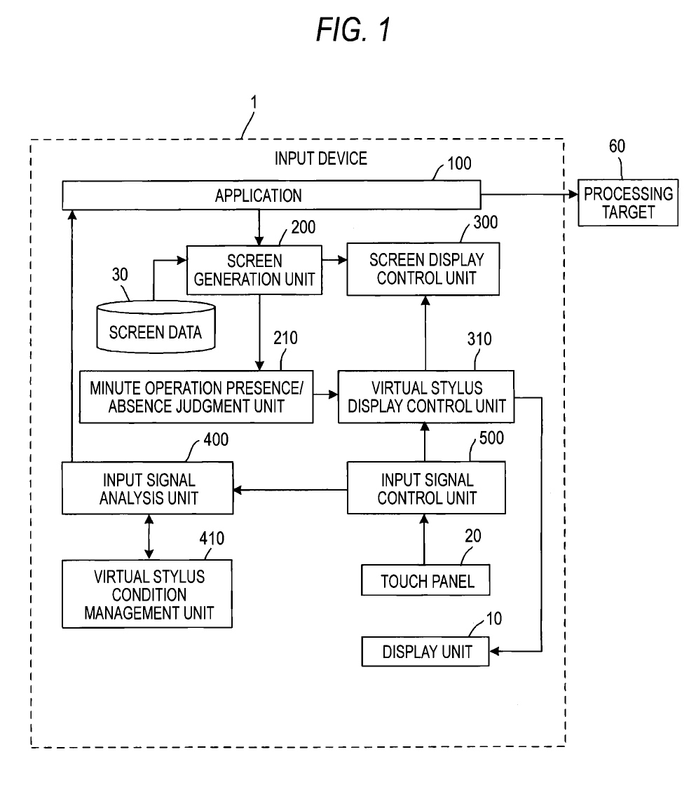

FIG. 1 is a block diagram showing a configuration of a main body of an input device for an electronic apparatus according to a first embodiment of the present invention.

The input device of the present embodiment is a device which is assumed to be used by a user to carry out input operation to an electronic apparatus such as a cellular phone terminal, a personal digital assistant (PDA), a portable music player, or a portable video game machine. The input device is mounted on the electronic apparatus and includes a touch panel having an input function by touch operation such as touching or tracing on an input screen on a display unit.

An input device 1 shown in FIG. 1 includes a display unit 10, a touch panel 20, a screen data storing unit 30, an application 100, a screen generation unit 200, a minute operation presence/absence judgment unit 210, a screen display control unit 300, a virtual stylus display control unit 310, an input signal analysis unit 400, a virtual stylus condition management unit 410, and an input signal control unit 500.

The application 100, the screen generation unit 200, the minute operation presence/absence judgment unit 210, the screen display control unit 300, the virtual stylus display control unit 310, the input signal analysis unit 400, the virtual stylus condition management unit 410, and the input signal control unit 500 respectively include a program carried out by a micro computer for controlling (not shown) or a dedicated control circuit. Moreover, the electronic apparatus mounted with the input device 1 includes a processing target 60 for carrying out processing by control carried out by the application 100 or the like in response to the input operation to the input device 1. The processing target 60 includes various elements provided for an electronic apparatus such as a display unit for carrying out various types of displays, an amplifier for outputting a sound signal, a program for reproducing content, and a setting control unit for carrying out various types of settings of the apparatus.

The display unit 10 is a device which can display various visible information such as a text, a graphic, and an image on a flat display and includes a liquid crystal display unit or the like. The touch panel 20 is an input device for operation which is provided in a laminated manner on the display screen of the display unit 10 and includes a transparent sheet-like member formed to be flat, and the sheet-like member forms the input screen. The touch panel 20 has a function of an input operation unit and periodically outputs a signal indicating contact on the input screen and coordinate information of a position at which the contact is detected. Therefore, when a user presses down on (touches) the input screen of the touch panel 20 by use of the user's own finger, a stylus pen, or the like, a signal indicating that a contact is made and coordinate information of the input position are output. Further, the touch panel 20 may be composed of various types of detection elements such as a pressure-sensitive type or an electrostatic type as long as the element can detect the presence or absence of a contact and a coordinate of an input position. At this time, the user can touch a specific position on the touch panel 20 (a position indicating the position where an object such as an operation button is displayed) while confirming the content of the display screen on the display unit 10 by a light that transmits the touch panel 20.

The screen data storing unit 30 retains various screen data of objects to be displayed on the display screen of the display unit 10. The screen data includes an operation object such as an operation button to be an operation target which can be operated by the user, or information indicating types, content, display position, size, (width in the X direction and the Y direction), or the like regarding other objects for display.

The application 100 is a program (middleware) to provide an interface to transmit and receive various types of data, control information, or the like between a higher individual application program (e.g., a program to provide a music reproduction function, or the like) and the input device 1 for providing a function for input operation. The application 100 carries out a corresponding command based on a control signal notified from the input signal analysis unit 400, and gives an instruction to the processing target 60 or the screen generation unit 200. At this time, if it is necessary to carry out a change, switching or the like of the display on the display unit 10, the application 100 gives an instruction to the screen generation unit 200 to carry out switching of the display screen or the like.

The screen generation unit 200 generates screen display information for the display screen which is a combination of various items of objects displayed as visible information on the display screen of the display unit 10. The object which can be displayed on the screen includes an operation object to be an operation target such as an operation button, a slide bar, or the like to which various functions required when the user operates an application software are allocated, or an icon or the like indicating an item such as a selectable content (e.g., a picture), and an object for display such as an image (e.g., background) existing only for the purpose of being displayed. Here, the operation object functions as a first operation inputting section which can carry out input operation via the touch panel 20. The screen generation unit 200 generates and outputs screen display information of the display screen by use of screen data including a button or layout to be displayed in each screen stored and managed by the screen data storing unit 300. Here, the screen generation unit 200 and the screen data storing unit 30 realize a function of an operation object display control unit for displaying at least one operation object on the display unit as visible information indicating an operation target portion for instructing execution of a predetermined function via the input operation unit.

The minute operation presence/absence judgment unit 210 judges screen display information of the display screen by a screen switching notification output from the screen generation unit 200 and recognizes whether or not the display screen includes an operation object of an operation target item which is difficult to be directly operated by a finger of the user (e.g., whether or not a minute operation is required). Specifically, in a case where one or more operation objects, which are operation targets, having a width in either the X direction or the Y direction of an area to be displayed (or an operation target area) smaller than a previously determined threshold (constant) or having a dimension smaller than a previously determined threshold (constant) are included, it is recognized that operation by use of a finger is not easy (highly challenging, or hardly possible). In other cases, it is recognized that it is easy to carry out direct operation by a finger. The minute operation presence/absence judgment unit 210 notifies the virtual stylus display control unit 310 of the recognition result.

The virtual stylus display control unit 310 generates display information of a virtual stylus in a case where it is judged on the basis of the recognition result from the minute operation presence/absence judgment unit 210 that direct operation by a finger is not easy. At this time, the virtual stylus display control unit 310 determines at which position the virtual stylus is displayed based on the information of operation position notified by the input signal control unit 500. Here, the virtual stylus in the present embodiment functions as a pointer used to indirectly operate the operation object being an operation target displayed on the screen and is a virtual input member which substitutes for a stylus pen or the like. This virtual stylus enables to realize functions equivalent to those in a case where a stylus pen or the like is used. Here, the virtual stylus (pointer) functions as a second operation inputting section which can carry out input operation to the operation object via the touch panel 20. Moreover, the virtual stylus display control unit 310 and the minute operation presence/absence judgment unit 210 realize a function of a pointer display control unit for displaying a pointer, which is for carrying out input of an instruction to the operation object via the input operation unit and is movable on the display screen, as visible information on the display unit.

Based on the screen display information of the display screen generated by the screen generation unit 200 and the display information of the virtual stylus notified by the virtual stylus display control unit 310, the screen display control unit 300 generates screen data of a screen in which this information is combined in real time and outputs the screen data to the display unit 10.

The input signal control unit 500 controls reception of a signal output from the touch panel 20 being an input device. Specifically, the input signal control unit 500 recognizes whether or not a signal input from the touch panel 20 is a noise. In a case where an appropriate signal which is not a noise is detected, the input signal control unit 500 detects an input position on the input screen and notifies information indicating the presence or absence of a contact and a coordinate of the contact position to the input signal analysis unit 400 and the virtual stylus display control unit 310 with a constant interval. Here, the input signal control unit 500 realizes a function of the input control unit that instructs processing based on an input signal from the input operation unit.

The input signal analysis unit 400 analyzes information input from the input signal control unit 500 to correlate the content of input operation by the user with a previously allocated command and outputs a control signal for instructing execution of a corresponding command to the application 100. Specifically, operation content such as an operation condition equivalent to simply pressing down a button (contact on), an operation condition indicating pressing down has been released (contact off), and a moving trajectory in a case where touch position is moved while pressing down (displacement of a contact position) and a coordinate of an operation position (input coordinate) are detected. An analysis result of the input signal analysis unit 400 is input to the processing target 60 and the screen generation unit 200 via the application 100. The input signal analysis unit 400 manages relevant information of display positions of each operation object which can be operated on each screen and functions allocated to the operation objects and can correlate the input operation to the touch panel 20 with a function to be executed by the input position.

The virtual stylus condition management unit 410 manages display position and operation condition of the virtual stylus and judges whether or not information of input operation notified by the input signal control unit 500 is an operation targeting the virtual stylus.

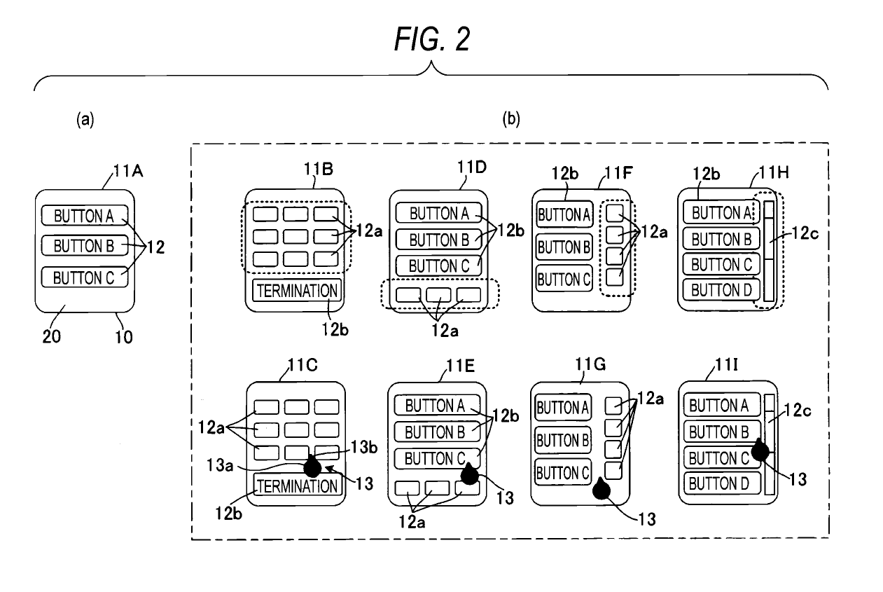

FIG. 2 is a view showing an example of displayed content on the display screen of the input device of the present embodiment. Here, various specific examples of display screens to be displayed on the display unit 10 are shown. A display screen 11A shown in FIG. 2 (a) shows an example where conditions to recognize that direct operation by a finger can be easily carried out match the minute operation presence/absence judgment unit 210 and respective display screens 11B to 11I show examples that match the condition where it is recognized that direct operation by a finger is not easy.

In the display screen 11A of FIG. 2 (a), operation objects 12 of three operation buttons to which functions of the operation buttons are respectively allocated are displayed with a relatively larger size. In this case, when the user touches the touch panel 20 to operate, detailed positioning is not required and respective operation objects 12 can be relatively easily operated by a finger.

On the other hand, display screens 11B, 11D, and 11F of FIG. 2 (b) contain small buttons 12a and large buttons 12b while the display screen 11H has large buttons 12b and a long and thin slider 12c as operation objects. In a case where the user touches the touch panel 20 on the position of the large button 12b to operate these buttons, it is still possible to directly operate the button by a finger. However, in a case where the user operates the small buttons 12a or the long and thin slider 12c, it is difficult to carry out direct operation by a finger. That is, in a case where the button 12a or the like is smaller compared to the size of an area where a finger touches on the touch panel 20, unless the position of the finger accurately matches the display position of each button, there is a possibility that the finger will touch adjacent buttons. Moreover, if the finger is moved closer to a button, the finger itself hides the button or the like, and it becomes difficult for the user to recognize the displayed content on the screen. Therefore, the positioning of the operation position is difficult.

Therefore, in the present embodiment, it is judged by the minute operation presence/absence judgment unit 210 that direct operation by a finger is not easy in a condition where a screen which includes the small buttons 12a or the long and thin slider 12c is displayed as in the display screens 11B, 11D, 11F, and 11H. Based on the recognition result, a virtual stylus 13 is displayed by the control of the virtual stylus display control unit 310 as in the display screens 11C, 11E, 11G, and 11I of FIG. 2 (b). In the examples of FIG. 2, the virtual stylus 13 includes a main area 13a having a relatively larger round shape and a fine-tipped projection area 13b projecting from a part of the main area 13a.

Display position of the virtual stylus 13 is automatically set by the virtual stylus display control unit 310 in the initial condition so that the virtual stylus 13 does not overlap on the display position of respective buttons 12a and 12b as shown in the display screens 11C, 11E, 11G, and 11I. At this time, the virtual stylus 13 is displayed in a position in the vicinity of a small button which applies to the display condition of the virtual stylus 13 or the button whose operation position may be hidden by a finger of the user, and wherein no operation object is displayed. Further, taking into consideration a case where the user operates the electronic apparatus with one hand, the virtual stylus 13 may be displayed within a range where the thumb or the like of a hand which is holding the electronic apparatus easily reaches (a position within a predetermined radius from a support of the base of a finger which is assumed to be used). Further, in the case of a portable terminal or the like, it is preferable from the viewpoint of operability that the virtual stylus 13 is displayed in a lower area of the display screen in the initial condition.

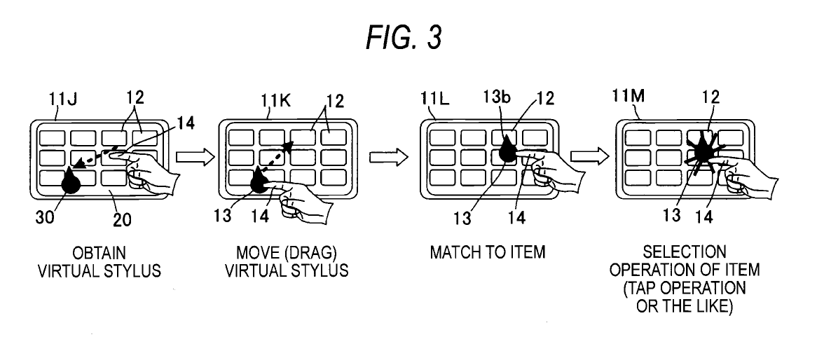

FIG. 3 is a view showing a specific example of operation procedures by the user to the display screen on the input device of the present embodiment. In a case where the virtual stylus 13 of the present embodiment is used, indirect operation as shown in FIG. 3 is enabled.

At this time, if the user moves his/her finger 14 to touch the position of the virtual stylus 13 in the condition of the display screen 11J, the virtual stylus 13 is obtained. If the user moves (drags) his/her finger 14 while maintaining a condition where the user touches the position of the virtual stylus 13 as in display screen 11K, display of the virtual stylus 13 is moved in response to the operation by the finger. Then, the virtual stylus 13 is moved to the position of the specific operation object 12 which is a target of the user as shown in display screen 11L. In this example, the tip position of the projection area 13b of the virtual stylus 13 is allotted as an operation position, a tip position of the projection area 13b of the virtual stylus 13 is matched to the target operation object 12. In this condition, if selection operation (tap operation) such as tapping the virtual stylus 13 (moving the finger away from the touch panel and touching the panel again for a brief time) by the finger 14 is carried out at a desired position as shown in display screen 11M, processing is carried out on the assumption that selection operation is carried out to the specific operation object 12 which matches the display position of the projection area 13b.

In the present embodiment, when the user directly operates the operation object 12 by a finger (a case of direct operation to the operation object), a position where the user's finger touches becomes an operation position and the operation object 12 which matches this position becomes an operation target. On the other hand, in a case where the user uses the virtual stylus 13 for indirect operation (indirect operation to the operation object in the position of the virtual stylus), position of the projection area 13b of the virtual stylus 13 is slightly off from the position where the user's finger touches becomes the operation position and the operation object 12 which matches the operation position becomes the operation target. Then, by either direct or indirect input operation, an input signal corresponding to the operation object 12 being an operation target is input. By use of the virtual stylus 13, it becomes possible to accurately determine the position of the projection area 13b because the projection area 13b is thin. Moreover, the projection area 13b is not hidden by the finger which moves the virtual stylus 13, therefore it is suitable to operate the small button 12a. Accordingly, enabling the use of the virtual stylus 13 improves operability in a case where a small object on the screen is operated.

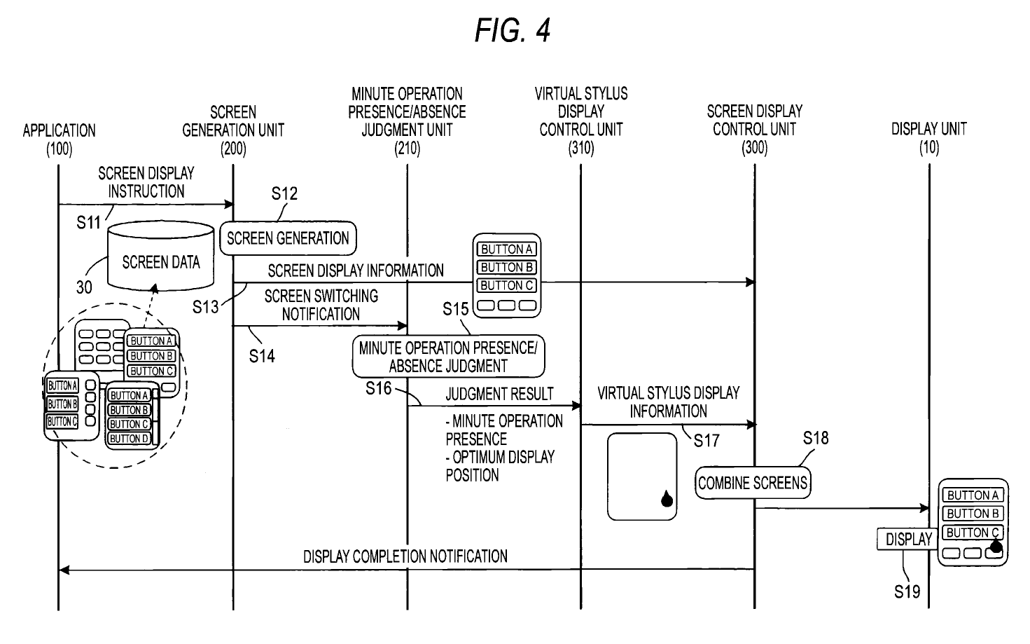

Next, a specific example of processing procedures of the input device according to the first embodiment will be explained with reference to FIG. 4. FIG. 4 is a sequence view showing performances with regard to display control of the virtual stylus in the input device of the first embodiment.

If a screen display instruction is generated in the processing of the application 100 (S11), the instruction is notified to the screen generation unit 200 and the screen generation unit 200 generates screen display information of an appropriate display screen (S12). This screen display information is generated from screen data including information such as type, content, display position, and size of an operation object or an object for display which is retained by the screen data storing unit 30. The screen display information generated by the screen generation unit 200 is notified to the screen display control unit 300 (S13). Moreover, the screen generation unit 200 transmits a display switching notification to the minute operation presence/absence judgment unit 210 (S14).

The minute operation presence/absence judgment unit 210 replies to the display switching notification from the screen generation unit 200 and carries out a judgment of the presence or absence of a minute operation on the display screen (S15). Here, the minute operation presence/absence judgment unit 210 judges whether or not direct operation of the operation object by a finger is easy (minute operation is required) from whether or not there exists a small operation object or the like based on the screen display information generated by the screen generation unit 200. If it is judged that direct operation is not easy, the minute operation presence/absence judgment unit 210 notifies information indicating that minute operation by use of the virtual stylus is required and information indicating the optimum display position of the virtual stylus to the virtual stylus display control unit 310 as a judgement result (S16). Regarding the optimum display position, the position is selected from areas where the operation object to be displayed on the screen does not exist.

The virtual stylus display control unit 310 notifies display information with regard to the virtual stylus to the screen display control unit 300 together with the information of initial display position of the virtual stylus when it is judged based on the judgment result notified from the minute operation presence/absence judgment unit 210 that minute operation using the virtual stylus is required (S17).

The screen display control unit 300 generates a display by combining the screen display information notified by the screen generation unit 200 and display information of the virtual stylus notified by the virtual stylus display control unit 310 in real time (S18), and transmits this screen data to the display unit 10. Moreover, a display completion notification is transmitted to the application 100. Then, the display unit 10 displays a display screen including the operation object to which the virtual stylus is combined (S19).

If the content as shown in the display screen 11A in FIG. 2 (a) is displayed by the above-mentioned operation, it is judged that direct operation by a finger can be easily carried out and the virtual stylus 13 is hidden. Moreover, if the content of each of the display screens shown in FIG. 2 (b) is displayed, it is judged that direct operation by a finger is not easy and the virtual stylus 13 is automatically displayed in the vicinity of the operation object.

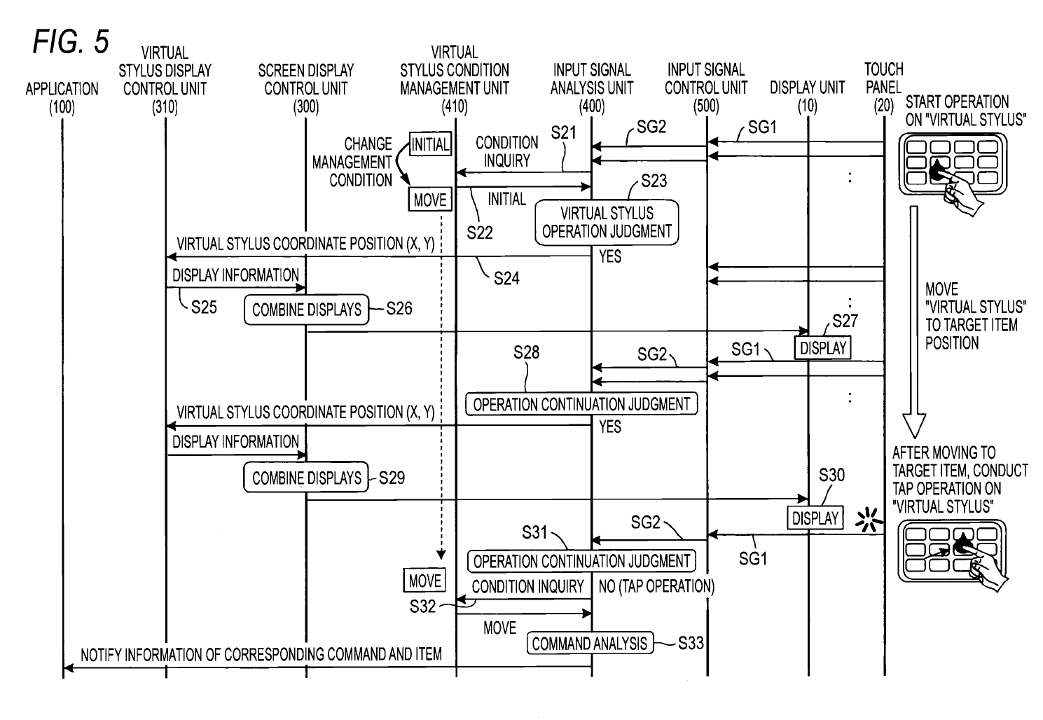

FIG. 5 is a sequence view showing performance with regard to reception of input operation in a condition where the virtual stylus is displayed in the input device of the first embodiment.

In a case where the user carries out input operation touching the touch panel 20, an operation detection signal SG1 including coordinate information indicating the input position on the touch panel 20 or the like is output to the input signal control unit 500 with a constant interval. The input signal control unit 500 removes noise from the operation detection signal SG1 output from the touch panel 20 to supply only effective information to the input signal analysis unit 400 as an operation signal SG2.

If the input signal analysis unit 400 receives the signal SG2 from the input signal control unit 500 in a condition where the virtual stylus 13 is displayed on the display screen 11 of the display unit 10, the input signal analysis unit 400 makes an inquiry about the condition of the virtual stylus 13 to the virtual stylus condition management unit 410 (S21). The virtual stylus condition management unit 410 manages the condition of the virtual stylus 13 as the “initial condition” right after the virtual stylus 13 is switched from the hidden condition to the display condition. Upon receiving the inquiry about the condition from the input signal analysis unit 400, the virtual stylus condition management unit 410 replies with a condition signal indicating “initial condition” to the input signal analysis unit 400 and at the same time switches the management condition of the virtual stylus 13 from the “initial condition” to the “moving condition” (S22).

After receiving the condition signal of the virtual stylus 13, the input signal analysis unit 400 judges whether or not the user operated the virtual stylus 13 (S23). Here, the input signal analysis unit 400 checks the distance between the coordinate of the position where the user touched the touch panel 20 and center position of the virtual stylus 13 displayed on the display unit 10 to judge whether or not the virtual stylus was operated by the user.

In a case where operation of the virtual stylus 13 by the user is detected, the input signal analysis unit 400 supplies the position coordinate of the latest operation signal SG2 to the virtual stylus display control unit 310 as the coordinate position of the virtual stylus (S24). The virtual stylus display control unit 310 uses the latest virtual stylus coordinate position input by the input signal analysis unit 400 to generate new display information in which position of the virtual stylus 13 to be displayed on the screen is corrected and supplies the display information to the screen display control unit 300 (S25).

The screen display control unit 300 combines the screen display information including the previously generated operation object and the latest display information of the virtual stylus input by the virtual stylus display control unit 310 to supply the latest screen data of the display to the display unit 10 (S26). Then, the display unit 10 displays the display screen in which the virtual stylus is moved and combined corresponding to the operation position (S27).

After detecting the user's operation to the virtual stylus 13, when the operation signal SG2 is received from the input signal control unit 500, the input signal analysis unit 400 judges whether or not the same operation is continued (S28). At this time, it is judged whether or not the user's finger keeps touching the touch panel 20. When the same operation is continued, the virtual stylus coordinate position to be supplied to the virtual stylus display control unit 310 is updated to the latest information. In response thereto, display information indicating the latest coordinate position of the virtual stylus output from the virtual stylus display control unit 310 is updated and the screen display information including the operation object and the latest display information of the virtual stylus are combined in the screen display control unit 300 (S29). Then, a display screen in which the position of the virtual stylus is further moved by continued operation is displayed on the display unit 10 (S30).

Due to the above-mentioned operation, if the user touches the touch panel 20 by his/her finger on the display position of the virtual stylus 13 and moves his/her finger on the touch panel 20 while maintaining the touching condition, the position of the virtual stylus 13 displayed on the screen of the display unit 10 is moved with the finger. That is, drag operation to move the virtual stylus 13 to a target item position can be carried out.

When the user indirectly operates the operation object after moving the virtual stylus 13 to the operation object 12 which is the target item by the above-mentioned operation, the user releases his/her finger from the touch panel 20 and subsequently carries out a tap operation of touching the touch panel 20 again on the position of the virtual stylus 13 for a brief time.

The input signal analysis unit 400 carries out operation continuation judgment similar to the case of receiving the operation signal SG2 (S31). In this case, it is judged that the operation is not continuation of the same operation (drag operation) but is tap operation. If the tap operation is detected, the input signal analysis unit 400 again makes an inquiry regarding the management condition of the virtual stylus 13 to the virtual stylus condition management unit 410 (S32). When the condition signal from the virtual stylus condition management unit 410 is “moving condition,” command analysis is executed (S33). That is, in a case where the tap operation is carried out after the virtual stylus was moved, it is regarded as indirect operation by use of the virtual stylus 13, coordinate of the display position of the projection area 13b is regarded as the operation position, and it is judged that a specific item displayed in the position which matches the operation position (the operation object 12, or the like) is operated by the user. Then, the input signal analysis unit 400 notifies that a command applies to the application 100 or information correlated with the operation item so that the command correlated with the item on the operation position is executed.

By the above-mentioned performance, even in a case where the operation object 12 displayed on the screen is small, the user can indirectly operate each of the operable items corresponding to the operation object 12 by use of the virtual stylus 13. In this case, since the operation position is specified by the projection area 13b of the virtual stylus 13, it can be easily carried out to accurately match the position of the operation position in a minute area. Therefore, it becomes possible to improve operability or operational efficiency in a case where the user carries out input operation by the touch panel.

Further, in the above-mentioned example, the virtual stylus displayed on the screen is moved at approximately the same speed as the finger of the user. However, depending on the case, there is a possibility that the operation object being an operation target may be hidden by the virtual stylus and cannot be seen. Therefore, moving speed of the virtual stylus in the drag operation may be controlled to be slower than the operation speed of the finger when the virtual stylus is moved by the finger.

Moreover, the above-mentioned example assumes a case where the shape or size of the virtual stylus displayed on the screen is fixed. However, the shape or size of the virtual stylus may be variable. For example, size or shape of a contact area in a case where the user touches the touch panel by his/her finger differs for each person. The contact area tends to be larger in the case of a person having a fat finger or a person who presses the touch panel strongly while the contact area becomes smaller in the case of a person having a thin finger or a person who holds up his/her fingertip in operation. Further, in the case of a person who has a habit of laying his/her finger during operation, the contact area may be a long and thin elliptical shape. Therefore, the shape or size or the like of the virtual stylus such as the size or shape of the contact area for each user may be adjusted so that viewability or operability of the screen can be optimum for each user.

Further, the contact area during operation of the touch panel may be detected to judge whether or not the operation is carried out by a finger or by a physically-existing stylus from the size of the contact area so that displaying/hiding of the virtual stylus can be switched. In this case, only in a case where it is judged that the operation is carried out by a finger, the above-mentioned display of the virtual stylus is carried out and input reception operation corresponding to the virtual stylus is carried out.

### Second Embodiment

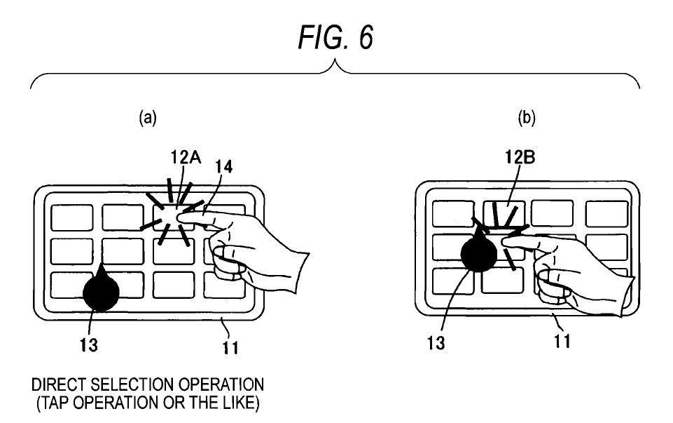

FIG. 6 is a view showing an example of display content of the display screen and performance in response to a user's operation of the input device of a second embodiment.

The second embodiment is a modification example of the above-mentioned first embodiment. Configuration of the input device in the second embodiment is similar to that of FIG. 1. However, performance of each unit and content of control are slightly changed. Explanation will be given here mainly on performances different from those of the first embodiment.

The first embodiment shows a case where the user carries out only indirect operation using the virtual stylus 13 in a condition where the virtual stylus 13 is displayed on the display screen of the display unit 10. However, in a case where the virtual stylus 13 is used, the user touches the position of the virtual stylus 13 by his/her finger to obtain the virtual stylus 13, moves the virtual stylus 13 by drag operation, and carries out instruction operation to the operation object 12 by tap operation or the like. In this case, while it is possible to carry out minute operation by use of the virtual stylus 13, instead, there may be a case where it takes time and effort to carry out operation. Moreover, for example, if operation of the large button 12b is carried out on a screen including the large button 12b as in the display screen 11D of FIG. 2 (b), minute positioning is not required. Therefore, operation directly touching the position of the operation object 12 by a finger enables more efficient operation than using the virtual stylus.

Therefore, in the second embodiment, in a condition where the virtual stylus 13 is displayed on the screen as in, for example, the display screen 11A shown in FIG. 6 (a), it is controlled that direct input operation of the user by not using the virtual stylus 13 is accepted. In this case, the user directly touches the operation object 12A being an operation target and has only to carry out tap operation or the like to complete the desired operation.

However, in a case where the operation object 12B which is an object the user desires to operate and the virtual stylus 13 are closely positioned as in the display screen 11 shown in FIG. 6 (b), it is difficult to distinguish direct input operation by the user from indirect operation by use of the virtual stylus 13 and there may be a case where incorrect operation unintended by the user is carried out. That is, there is a possibility that due to positioning deviation between the operation position where the user desires and actual operation position, another object adjacent to the target operation object may be operated. Taking this into consideration, the condition of the virtual stylus 13 is managed and availability of operation to the virtual stylus 13 is switched corresponding to the condition in the second embodiment. Moreover, processing is added for a case where the operation position is in the vicinity of the virtual stylus 13.

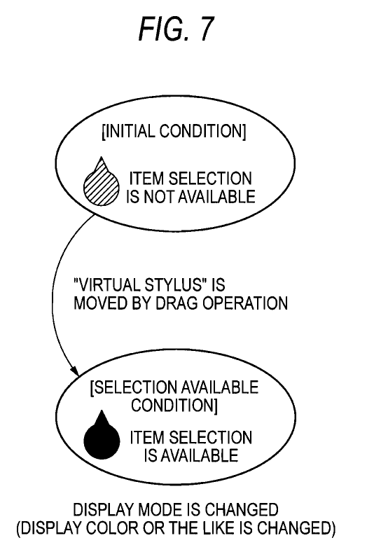

FIG. 7 is a condition transition diagram showing transition of condition of the virtual stylus displayed on the display screen. In the second embodiment, condition of the virtual stylus 13 is managed in either the “initial condition” where selection of an item (such as instruction operation to the operation object 12) cannot be carried out or the “selection available condition” where selection of an item can be carried out by the virtual stylus condition management unit 410 to prevent occurrence of incorrect operation.

Here, the virtual stylus condition management unit 410 manages the virtual stylus 13 as in the “initial condition” where the virtual stylus 13 cannot select an item right after the virtual stylus 13 is displayed on the screen and when the virtual stylus 13 is moved by the drag operation by the user, switches the virtual stylus 13 to the “selection available condition.” Moreover, for the user to easily recognize and understand the difference in conditions of the virtual stylus 13, the display modes of the virtual stylus 13 in the “initial condition” and the “selection available condition” are changed. For example, display mode such as display color, pattern, or shape of the virtual stylus is automatically switched corresponding to the condition. Then, the input signal analysis unit 400 judges input operation corresponding to the condition of the virtual stylus, and carries out relevant processing.

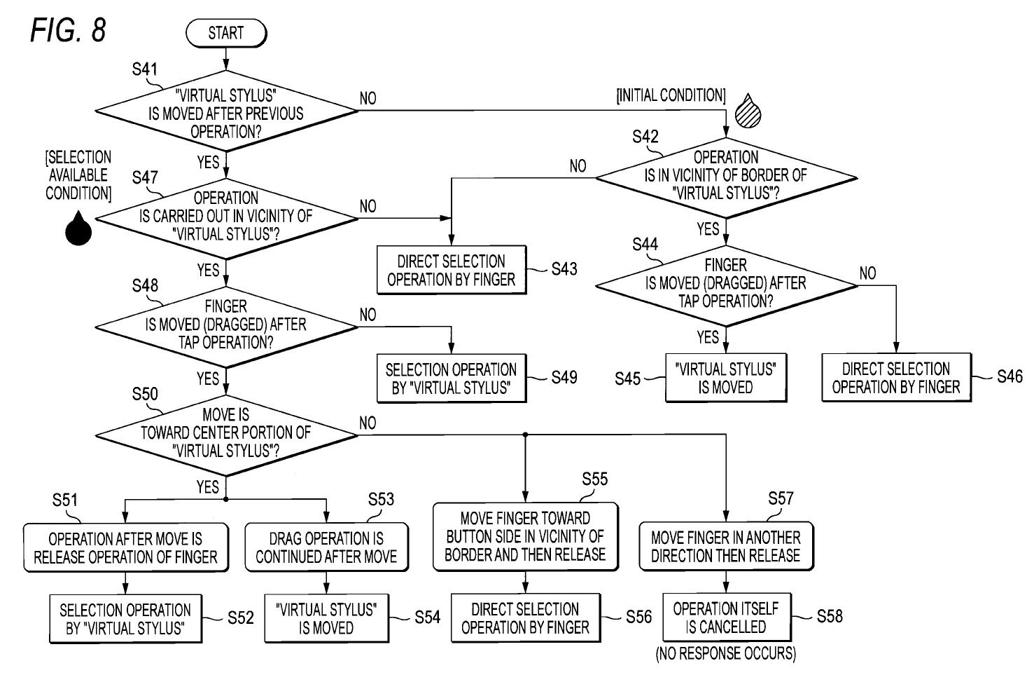

FIG. 8 is a flowchart showing processing procedures when input operation to the virtual stylus is carried out in the second embodiment. In a case where the tap operation or the like by the user to the touch panel 20 is detected, the input signal analysis unit 400 carries out performance as shown in FIG. 8.

First, in the Step S41, the input signal analysis unit 400 judges the condition managed by the virtual stylus condition management unit 410 (whether the “initial condition” or the “selection available condition”) as for the virtual stylus 13 displayed on the display screen. Here, the virtual stylus condition management unit 410 judges whether or not the virtual stylus was moved after the previous operation (tap operation or the like). If the virtual stylus was not moved, the virtual stylus condition management unit 410 assumes that the virtual stylus is in the “initial condition” and if the virtual stylus was moved, the virtual stylus condition management unit 410 assumes that the virtual stylus is in the “selection available condition” to understand the condition of the virtual stylus 13, thus the condition of the virtual stylus 13 is grasped. Then, the input signal analysis unit 400 carries out the processing in S42 to S58 to receive input operation from the user corresponding to the condition of the virtual stylus 13 judged as above.

In a case where the virtual stylus 13 is in the “initial condition,” the process proceeds to the Step S42 and the input signal analysis unit 400 judges whether or not the operation position for tap operation or the like is the operation in the vicinity of the border of the virtual stylus 13. At this time, it is judged whether or not the distance from the border of the outline of the virtual stylus 13 to the operation position is shorter than a predetermined distance and it is the condition where it is difficult to distinguish indirect operation by use of the virtual stylus from direct operation to the operation object (e.g., condition of FIG. 6 (b).)

In a case where the operation position is not in the vicinity of the border of the virtual stylus 13 in Step S42, it is judged that the possibility of direct operation is high and the process proceeds to Step S43. In the Step S43, the input signal analysis unit 400 receives operation by a finger as direct operation, assumes that the user operated the operation object 12 or the like displayed in, for example, a position corresponding to the center position of the contact area of the finger, and executes corresponding processing.

On the other hand, in a case where the operation position is in the vicinity of the border of the virtual stylus 13 in the Step S42, it is judged that it is difficult to distinguish whether the operation was the direct operation or indirect operation and the process proceeds to Step S44. In the Step S44, the input signal analysis unit 400 judges whether or not movement of the finger (drag operation) was detected after the tap operation by the user was detected.

In a case where moving operation of the finger is detected in the Step S44, the process proceeds to Step S45. In the Step S45, the virtual stylus display control unit 310 moves the position of the virtual stylus 13 on the display screen along the movement of the operation position of the finger under the control by the input signal analysis unit 400.

On the other hand, in a case where the moving operation of the finger is not detected in Step S44, the process proceeds to Step S46. In the Step S46, similar to the Step S43, the input signal analysis unit 400 receives the operation by the finger as the direct operation, assumes that the user operated the operation object 12 or the like displayed in, for example, a position corresponding to the center position of the contact area of the finger, and executes corresponding processing.

Moreover, in a case where the virtual stylus 13 is in the “selection available condition” in the Step S41, the process proceeds to Step S47 and the input signal analysis unit 400 judges whether or not the operation position of tap operation or the like was carried out in the vicinity of the border of the virtual stylus 13.

In a case where the operation position is not in the vicinity of the border of the virtual stylus 13 in the Step S47, it is judged that the possibility of direct operation is high and the process proceeds to the Step S43. Then, the input signal analysis unit 400 receives operation by a finger as direct operation, assumes that the user operated the operation object 12 or the like, and executes corresponding processing.

On the other hand, in a case where the operation position is in the vicinity of the border of the virtual stylus 13 in the Step S47, the input signal analysis unit 400 judges it is difficult to distinguish direct operation from indirect operation and the process proceeds to Step S48. In the Step S48, similar to the Step S44, the input signal analysis unit 400 judges whether or not movement of the finger (drag operation) was detected after the tap operation by the user was detected.

In a case where moving operation of the finger is not detected in the Step S48, the process proceeds to Step S49. In the Step S49, the input signal analysis unit 400 receives the operation by the finger as the indirect operation by use of the virtual stylus 13. That is, the input signal analysis unit 400 assumes that the operation object 12 or the like displayed in a position corresponding to the tip position of the projection area 13b of the virtual stylus 13 on the screen operated by the finger is operated by the user and executes corresponding processing.

On the other hand, in a case where moving operation of the finger is detected in the Step S48, the process proceeds to Step S50 and the input signal analysis unit 400 judges moving direction of the operation. Here, it is judged whether or not the moving direction is facing toward the center portion of the virtual stylus 13. Then, in a case where the moving direction is facing toward the center portion of the virtual stylus 13, Step S51 or S53 is executed corresponding to the following operation.

Here, in a case where the operation after moving is the release of the finger (operation to release the finger from the touch panel 20) (Step S51), the process proceeds to Step S52 and the input signal analysis unit 400 receives the operation by the finger as the indirect operation using the virtual stylus 13 similar to the Step S49. Then, processing corresponding to the operation position is executed.

Moreover, in a case where the drag operation is continued after moving (Step S53), the process proceeds to Step S54, the input signal analysis unit 400 moves the position of the virtual stylus 13 on the display screen along the movement of operation position of the finger similar to the Step S45.

In a case where the moving direction is not facing toward the center portion of the virtual stylus 13 in the Step S50, Step S55 or S57 is executed corresponding to the operation of that time.

Here, in a case where releasing operation is detected after the finger is moved to a button in the vicinity of the operation position (the operation object 12) (Step S55), the process proceeds to Step S56 and the input signal analysis unit 400 receives the operation by the finger as the direct operation similar to the Step S43. Then, processing corresponding to the operation position is executed.

Moreover, in a case where releasing operation is detected after the finger is moved in an other direction than facing toward the button in the vicinity of the operation position (operation object 12) (Step S57), the process proceeds to Step S58 and the input signal analysis unit 400 regards the operation itself as null to cancel receiving of the operation, so that no reaction will occur.

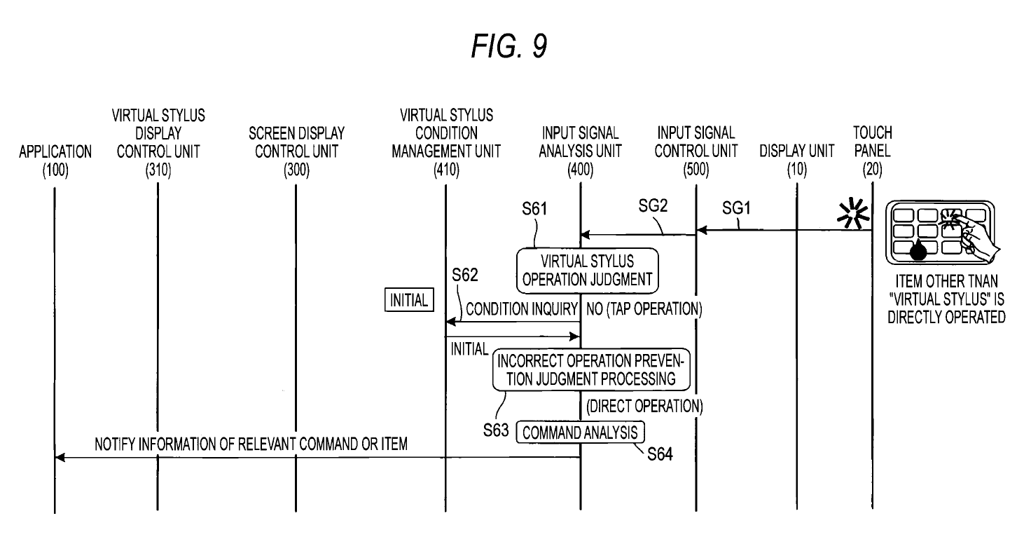

FIG. 9 is a sequence view showing performance with regard to input operation reception in a condition where the virtual stylus is displayed in the input device of the second embodiment.

The input signal analysis unit 400 executes virtual stylus operation judgment based on the condition of the operation signal SG2 input from the input signal control unit 500 (S61). Here, it is judged whether or not the drag operation was continued, that is, whether the drag operation was continued or other tap operation was detected.

Here, in a case where the tap operation is detected, the input signal analysis unit 400 makes an inquiry to the virtual stylus condition management unit 410 regarding the management condition of the virtual stylus 13 (S62), and obtains a reply to the inquiry (initial condition or selection available condition). Subsequently, an “incorrect operation prevention judgment processing” is carried out (S63). The “incorrect operation prevention judgment processing” is equivalent to the above-mentioned processing in FIG. 8. As a result of the incorrect operation prevention judgment processing, it is recognized whether the operation is the direct operation to the operation object 12 or the indirect operation by use of the virtual stylus 13. The input signal analysis unit 400 specifies the operation position corresponding to whether the operation was direct operation or indirect operation and executes corresponding processing. For example, if the operation was direct operation to the operation object 12, command analysis corresponding to the operation position is executed (S64). In this case, the input signal analysis unit 400 judges that a specific item (operation object 12 or the like) displayed on a position which matches the operation position was operated by the user and notifies information regarding the corresponding command or operation item to the application 100 so that the command correlated with the item on the operation position is executed.

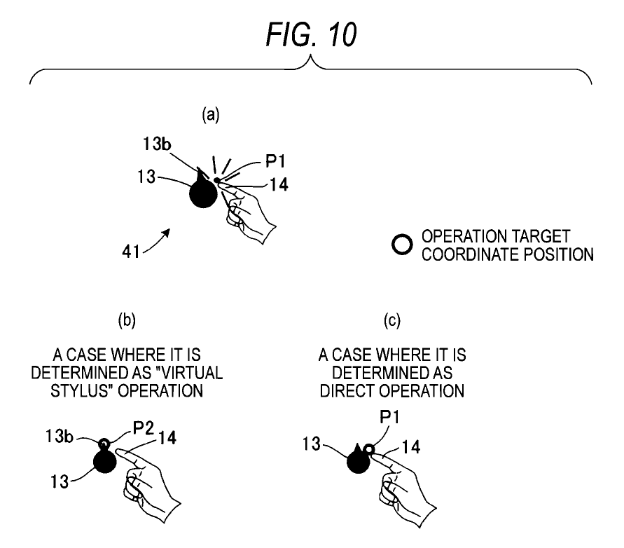

FIG. 10 is a schematic view showing a difference in operation position corresponding to the judgment result of whether the operation was direct operation or indirect operation.

For example, as shown in FIG. 10 (a), in the display screen 41, in a case where the user touches the touch panel 20 by the finger 14 in a position which is in the vicinity of the outline of display of the virtual stylus 13 (P1), the operation position being the operation target differs depending on whether the judgment result of incorrect operation prevention judgment processing is direct operation or indirect operation. That is, in a case where it is judged that the operation was indirect operation using the virtual stylus 13, the tip position of the projection area 13b of the virtual stylus 13 (P2) becomes a coordinate position of an operation target as shown in FIG. 10 (b). Moreover, in a case where it is judged that the operation was direct operation, the position where operation by the finger 14 was detected (P1) directly becomes the operation position as shown in FIG. 10 (c).

Thus, according to the second embodiment, direct operation by which the position of the user's finger becomes an instruction point (operation position) of an operation target and indirect operation by which the position indicated by the virtual stylus becomes the operation position can be used depending on the necessity. Moreover, since the condition of the virtual stylus is distinguished and managed as the “initial condition” where an item cannot be selected and the “selection available condition” where an item can be selected, occurrence of an incorrect operation unintended by the user can be inhibited. Further, in this case, the user can easily recognize the condition of the virtual stylus by the display mode of the virtual stylus.

### Third Embodiment

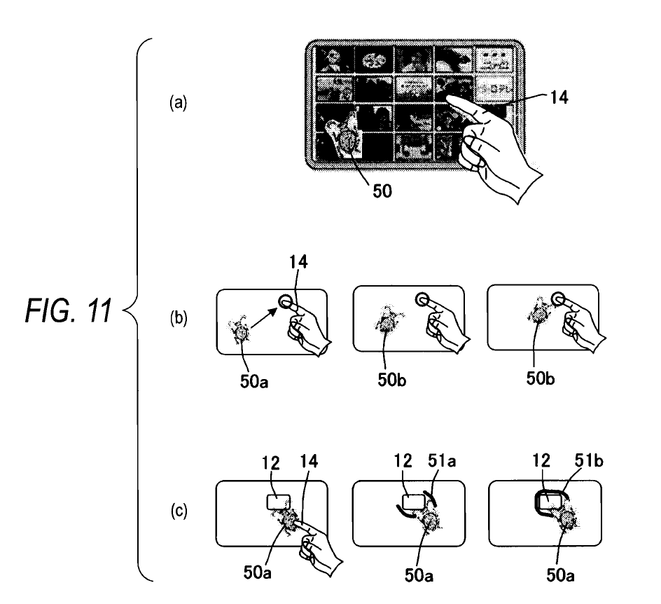

FIG. 11 is a view showing an example of display content on the display screen and performance in response to a user's operation of the input device of a third embodiment.

The third embodiment is another modification of the above-mentioned first embodiment. Although the input device of the third embodiment has a configuration similar to that in FIG. 1, performance of each unit or content of control is slightly changed. Here, explanation will be given mainly on performances different from those of the first embodiment.

In the first embodiment, an example was shown where the pen-shaped virtual stylus 13 having a fixed shape is displayed on the screen as a pointer for a user to carry out indirect operation. However, artifice of the pointer enables to notify, for example, difference in operating situation, to the user and to utilize for improvement in operability. Moreover, it becomes possible to add an amusement factor when displaying the virtual stylus. Therefore, in the third embodiment, a character pattern having a changeable shape, size or the like is used as the pointer instead of the above-mentioned virtual stylus 13.

The example of FIG. 11 displays a bug-like character pattern as a pointer 50 as shown in FIG. 11 (a). In this case, for example, a plurality of patterns such as a pattern 50a and a pattern 50b respectively facing different directions are used, as shown in FIG. 11 (b). Moreover, it is possible to carry out animation display in the FIG. 11 (b) such that when the user carries out drag operation by the finger 14, the pointer 50 follows the movement of the finger 14 a little later “in a hasty manner.” Further, when the pointer 50 of the character pattern is displayed, the pointer 50 may be moved slowly on the display screen to be displayed. Thus, it becomes possible to prevent the operation object on the display screen from being hidden by the pointer or being difficult to be seen.

Moreover, an example shown in FIG. 11 (c) is for providing selection displays 51a and 51b in addition to the pointer 50 so that the operation object 12 selected by the pointer 50 is surrounded by the selection display to change the pattern of the pointer which makes it possible for the user to easily recognize a selection item, selection condition or the like. In this case, after the selection item is fixed by selection operation such as tap operation by the finger 14, it is possible to carry out animation display within a scope where it does not impair operability. For example, the pointer 50 itself moves around the operation object 12 being the selection item.

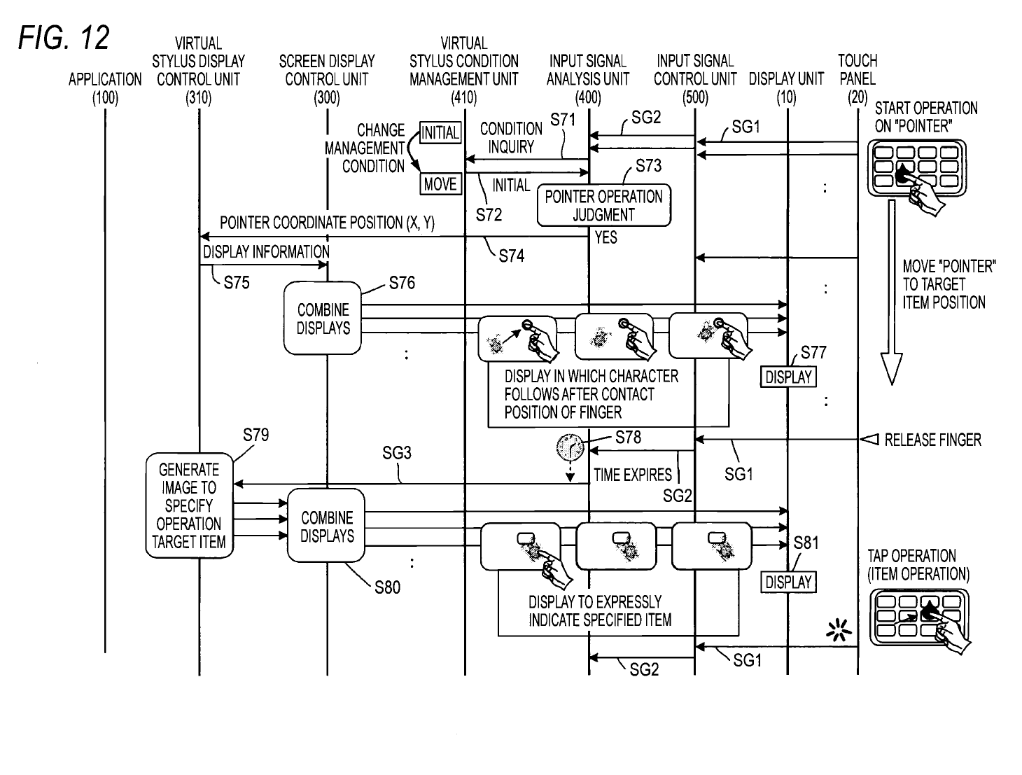

FIG. 12 is a sequence view showing performance with regard to input operation reception in a pointer display condition in the input device of the third embodiment. Moreover, in the third embodiment, the virtual stylus condition management unit 410 has a function to manage the condition of the pointer 50 instead of the virtual stylus 13. Content of processing is basically the same as that of the first embodiment although the name of a target of management differs.

When the input signal analysis unit 400 receives the signal SG2 from the input signal control unit 500 in a condition where the pointer 50 is displayed on the display screen 11 of the display unit 10, the input signal analysis unit 400 makes an inquiry regarding the condition of the pointer 50 to the virtual stylus condition management unit 410 (S71). The virtual stylus condition management unit 410 manages the condition of the pointer 50 as in the “initial condition” right after the pointer 50 is switched from the hidden condition to the display condition. Upon receiving the inquiry from the input signal analysis unit 400, the virtual stylus condition management unit 410 replies with a condition signal indicating the “initial condition” to the input signal analysis unit 400 and at the same time switches the management condition of the virtual stylus 13 from the “initial condition” to the “moving condition” (S72).

After receiving the condition signal of the pointer 50, the input signal analysis unit 400 judges whether or not the operation was the user's operation to the pointer 50 (S73). Here, the input signal analysis unit 400 checks the distance between the coordinate of the position of the touch panel on which the user touched and the center position of the pointer 50 displayed on the display unit 10 to judge whether or not operation was made by the user to pointer 50.

In a case where the user's operation to the pointer 50 is detected, the input signal analysis unit 400 supplies a position coordinate of the latest operation signal SG2 to the virtual stylus display control unit 310 as a pointer coordinate position (S74). The virtual stylus display control unit 310 uses the latest pointer coordinate position input from the input signal analysis unit 400 to generate new display information in which the position of the pointer 50 to be displayed on the screen is corrected and supplies this display information to the screen display control unit 300 (S75).

The screen display control unit 300 combines the screen display information including a previously generated operation object and latest display information of the pointer input from the virtual stylus display control unit 310 and supplies the latest screen data of the screen to the display unit 10 (S76). Then, the display unit 10 displays a display screen in which the pointer is moved and combined corresponding to the operation position and combined (S77). Here, for example, in a case where the finger 14 moves while touching the screen, a pointer coordinate position of the pointer is allocated in a position which is slightly displaced in front of the position coordinate of the operation signal SG2 indicating the position of the finger 14 so that a character of the pointer 50 displayed moves following the finger 14. Thus, the display in which the character follows after the position of the finger is carried out.

When the input signal analysis unit 400 receives the operation signal SG2 indicating that the finger 14 was removed from the touch panel 20 from the input signal control unit 500 after detecting moving operation (drag operation) of the pointer 50, the input signal analysis unit 400 activates a timer and waits for a predetermined period of time (S78). Then, after the predetermined period of time elapses, the input signal analysis unit 400 supplies a display switching signal SG3 with regard to the display mode of the pointer 50 to the virtual stylus display control unit 310.

Upon receiving the display switching signal SG3 from the input signal analysis unit 400, the virtual stylus display control unit 310 generates an image for specifying an operation target item (the operation object 12 or the like being an operation target) (S79). In this case, for example, an image to which the selection displays 51a and 51b are added as shown in FIG. 11 (c) is generated. In response thereto, the screen display information including the operation object and display information of the pointer to which display for specifying a selection item is added are combined in the screen display control unit 300 (S80). Then, the display screen including the pointer 50 to which the selection displays 51a and 51b are added is displayed on the display unit 10 (S81). Thus, in the condition where the input of selection operation of the operation object 12 is waited after the movement operation of the pointer 50, display such that the specified item of the operation object 12 is expressly displayed by the selection displays 51a and 51b.

As mentioned above, in the third embodiment, the user intuitively understands the current operation condition such as movement or selection from the change in display mode of the form of the pointer by animation display of the pointer as a character pattern, and adding the selection displays to specify the selection item after movement of the pointer, which enables the efficient input operation using the pointer. Moreover, it also becomes possible to add an amusement factor to the display of the pointer so improve usability.

Here, it should be understood that the present invention is not limited to the above-mentioned embodiments and it is intended to cover all changes and modifications of the examples of the invention by those skilled in the art on the basis of the foregoing description and conventional art.

The present application is based on the Japanese Patent Application (Japanese Patent Application No. 2008-034330) and contents of which are incorporated herein by reference.

### INDUSTRIAL APPLICABILITY

The present invention has an effect which can improve operability in a case where a user carries out input operation by use of a touch panel even if the operation target is small and enable efficient input operation by the user in various situations. The present invention is useful as an input device for an electronic apparatus that can be used for input operation for an electronic apparatus such as a cellular phone terminal, a portable information terminal (personal digital assistant), a portable music player, and a portable video game machine.

1. An input device for an electronic apparatus, comprising:
a display unit that can display visible information regarding an input operation;
an input operation unit that includes a touch panel having an input function by a touch operation on an input screen corresponding to a display screen of the display unit;
an input control unit that instructs a processing based on an input signal from the input operation unit;
an operation object display control unit that displays at least one operation object indicating an operation target portion for instructing execution of a specific function on the display unit as the visible information via the input operation unit; and
a pointer display control unit that displays a pointer being movable on the display screen for carrying out input of an instruction to the operation object via the input operation unit in a case where a width or a size of a display area of the operation object displayed on the display unit or an area for receiving the input operation is equal to or smaller than a predetermined value and that hides the pointer in a case where the width or the size of the display area of the operation object displayed on the display unit or the area for receiving the input operation is equal to or greater than a predetermined value,
wherein the pointer display control unit sets a display position of the pointer in the vicinity of an area including an operation object corresponding to a display condition of the pointer, and the display position of the pointer does not overlap the operation object when displaying the pointer.

2. An input device for an electronic apparatus, comprising:
a display unit that can display visible information regarding an input operation;
an input operation unit that includes a touch panel having an input function by a touch operation on an input screen corresponding to a display screen of the display unit;
an input control unit that instructs a processing based on an input signal from the input operation unit;
an operation object display control unit that displays at least one operation object indicating an operation target portion for instructing execution of a specific function on the display unit as the visible information via the input operation unit; and
a pointer display control unit that displays a pointer being movable on the display screen for carrying out input of an instruction to the operation object via the input operation unit in a case where a contact area on the input screen of the input operation unit during a touch operation is equal to or greater than a predetermined value and that hides the pointer in a case where the contact area on the input screen of the input operation unit during the touch operation is equal to or smaller than a predetermined value.

3. The input device for the electronic apparatus according to claim 2, wherein the pointer display control unit determines that the input operation is conducted by a finger of a user in a case where the contact area is equal to or greater than the predetermined value and that the input operation is conducted by a stylus in a case where the contact area is equal to or smaller than the predetermined value.

4. The input device for the electronic apparatus according to claim 1, wherein the input control unit can receive an input signal by either direct operation to the operation object on the display screen or indirect operation to the operation object on the position of the pointer as the input operation corresponding to the display screen of the display unit.

5. The input device for the electronic apparatus according to claim 4, wherein the pointer display control unit sets a first condition where the indirect operation to the operation object by the pointer is invalid and a second condition where the indirect operation to the operation object by the pointer is valid when displaying the pointer, and switches the first condition and the second condition in accordance with a detection situation of the input operation to the pointer.

6. The input device for the electronic apparatus according to claim 5, wherein the pointer display control unit switches display mode for displaying of the pointer in accordance with the first condition and the second condition.

7. The input device for the electronic apparatus according to claim 5, wherein the pointer display control unit adds a selection display indicating that an operation object at the display position of the pointer or in the vicinity of the display position of the pointer is selected by the pointer in a case where the pointer is in the second condition.

8. The input device for the electronic apparatus according to claim 1, wherein the pointer display control unit uses character patterns, whose form can be changed, as the pointer and carries out animation display of the character pattern.

9. The input device for the electronic apparatus according to claim 1, wherein the pointer display control unit changes a form including at least either a shape or a size of the pointer corresponding to a form of the contact area in the input screen of the input operation unit during the touch operation.

10. An electronic apparatus mounted with the input device according to claim 1.
